(19) United States
(12) Patent Application Publication
(10) Pub. No.: US 2006/0284501 A1
(43) Pub. Date: Dec. 21, 2006

(54) Vibration motor

(75) Inventors: Takahiro Takagi, Ueda-shi (JP); Masato Nakamura, Ueda-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SANYO SEIMITSU CO., LTD., Ueda-shi (JP); SANYO ELECTRIC CO., LTD., Moriguchi-shi (JP)

(21) Appl. No.: 11/446,507

(22) Filed: Jun. 5, 2006

(30) Foreign Application Priority Data
Jun. 7, 2005 (JP) 2005-166686

(51) Int. Cl. H02K 7/06

(52) U.S. Cl. 310/81

(57) ABSTRACT

A vibration motor able to greatly suppress lateral shaking of conduction terminals, provided with a pair of motor power parts provided at an end cap closing an open end of a motor case, a pair of plate-shaped conduction terminals including contact faces for abutting against elastically retractable power contacts provided at the board side and connected corresponding to the motor power parts, and a spacer formed integrally with the end cap and abutting against a circumferential surface of the motor case to separate the contact faces from the circumferential surface, wherein the first contact face integrally has a first abutting part abutting against a first side face of the spacer and the second contact face integrally has a second abutting part abutting against a second side face different from the first side face of the spacer.

### CROSS-REFERENCE TO RELATED APPLICATIONS

This application is based upon and claims a priority of Japanese Patent Application No. 2005-166686, filed Jun. 7, 2005, the contents being incorporated herein by reference.

### BACKGROUND OF THE INVENTION

1. Field of the Invention

The present invention relates to a vibration motor having an eccentric weight, more particularly relates to a vibration motor mounted by making plate-shaped conduction terminals abut against elastically retractable power contacts provided on the board side.

2. Description of the Related Art

In the past, in general, a vibration motor has a pair of springy conduction terminals and is mounted in a state with the conduction terminals made to abut against power patterns on the board side. However, the vibration of the vibration motor itself and external vibration or impact force results in the springy conduction terminals easily laterally shaking on the power patterns and electrical connection being disturbed. To deal with this, the structure shown in Japanese Patent Publication (A) No. 2002-330567 has been disclosed.

That is, the elastomer grommet covering the body of teh vibration motor (motor case) is provided with a pair of recesses matched with the shapes of the front ends of the conduction terminals across the opposing faces. The front ends of the pair of conduction terminals are positioned in the pair of recesses and in that state made to abut against the power patterns on the board side.

However, the conduction terminals are extremely springy. Further, the grommet is an elastomer (rubber). Therefore, it has unnecessary vibration separate from the rotational vibration of the eccentric weight. The conduction terminals are even more susceptible to lateral shaking.

### SUMMARY OF THE INVENTION

Therefore, an object of the present invention is to provide a vibration motor able to greatly suppress lateral shaking of conduction terminals.

To achieve the object, the present invention provides a vibration motor having a pair of motor power parts provided at an end cap closing an open end of a motor case, a pair of plate-shaped conduction terminals including contact faces for abutting against elastically retractable power contacts provided at the board side and connected corresponding to the motor power parts, and a spacer formed integrally with the end cap and abutting against a circumferential surface of the motor case to separate the contact faces from the circumferential surface, wherein the first contact face integrally has a first abutting part abutting against a first side face of the spacer and the second contact face integrally has a second abutting part abutting against a second side face different from the first side face of the spacer.

The spacer is formed integrally with the end cap and abuts against the circumferential surface of the motor. Further the power contacts on the board side are elastically retractable. Therefore, it is not necessary to give the spacer on the vibration motor side and the plate-shaped conduction terminals any special elasticity and possible to suppress unnecessary vibration. Further, the first contact face integrally has a first abutting part abutting against a first side face of the spacer and the second contact face integrally has a second abutting part abutting against a second side face different from the first side face of the spacer, so the distance between the contact faces can be constrained and their lateral shaking can be greatly suppressed.

The abutting parts preferably project out from the front ends of the pair of contact faces near the outer edges opposite to the inner edges where the faces adjoin each other and are bent toward the circumference of the motor case.

Since the abutting parts press against the spacer at positions furthest away from the base ends of the plate-shaped conduction terminals, they provide support at the two ends in structure and can suppress unnecessary vibration. Further since the abutting parts are formed near the outer edges of the contact faces, it is possible to increase the widths of the contact faces to secure greater room for contact with the power contacts on the board side, and the pair of contact faces do not have to project out from the motor case.

Each of the pair of plate-shaped conduction terminals is formed into an L-shape having a bent part for connection to a motor power part, but it is preferable to use a terminal part integrally provided with an attachment piece, connecting in a forked manner to the pair of L-shaped plate-shaped conduction terminals, projecting out from the pair of bent parts. A separating groove may be provided between the pair of bent parts and the attachment part.

The attachment piece of the terminal part is held and the pair of the bent parts are attached and connected to the pair of motor power parts and, in that state, the pair of plate-shaped conduction terminals are held at a predetermined distance by being connected by the attachment piece in a forked manner, so the plate-shaped conduction terminals can be connected while maintaining parallelism without separating. Further, since the attachment piece stretches out in the radial direction over the end face of the end cap body, it is possible to hold the attachment piece and bend it at the separating groove to easily break it off so as to remove the attachment piece from the plate-shaped conduction terminals. This increases the work efficiency when attaching the plate-shaped conduction terminals.

In the present invention, the spacer is formed integrally with the end cap and abuts against the circumferential surface of the motor. Further the power contacts on the board side are elastically retractable. Therefore, it is not necessary to give the spacer on the vibration motor side and the plate-shaped conduction terminals any special elasticity and possible to suppress unnecessary vibration. Further, the first contact face integrally has a first abutting part abutting against a first side face of the spacer and the second contact face integrally has a second abutting part abutting against a second side face different from the first side face of the spacer, so the distance between the contact faces can be constrained and their lateral shaking can be greatly suppressed.

### BRIEF DESCRIPTION OF THE DRAWINGS

These and other objects and features of the present invention will become clearer from the following description of the preferred embodiments given with reference to the attached drawings, wherein:

FIG. 1 is an assembled perspective view showing a vibration motor according to an embodiment of the present invention;

FIG. 2 is a disassembled perspective view with part of the vibration motor detached;

FIG. 3 is a disassembled perspective view of the state shown in FIG. 2 seen from another angle;

FIG. 4 is a perspective view showing a pair of plate-shaped conduction terminals used for the vibration motor;

FIG. 5 is a side view of the state of mounting the vibration motor on a board; and

FIG. 6A is a front view of a terminal part provided with a pair of plate-shaped conduction terminals, while FIG. 6B is a right side view of that terminal part.

### DESCRIPTION OF THE PREFERRED EMBODIMENTS

Next, an embodiment of the present invention will be explained based on the attached drawings.

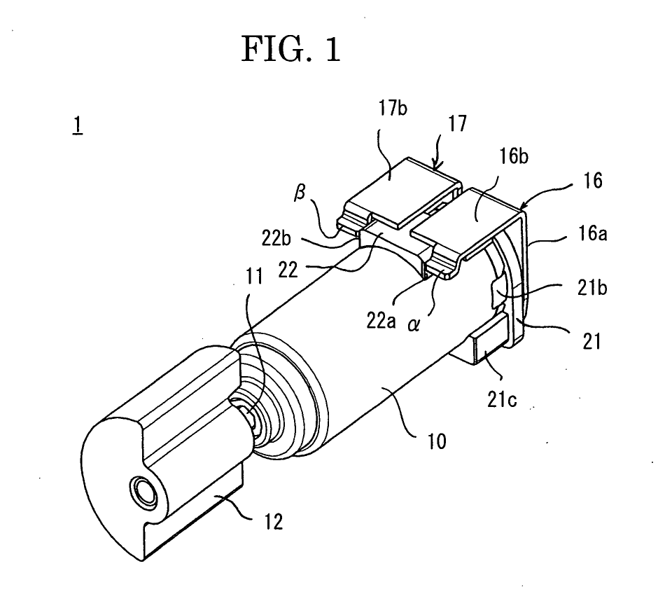

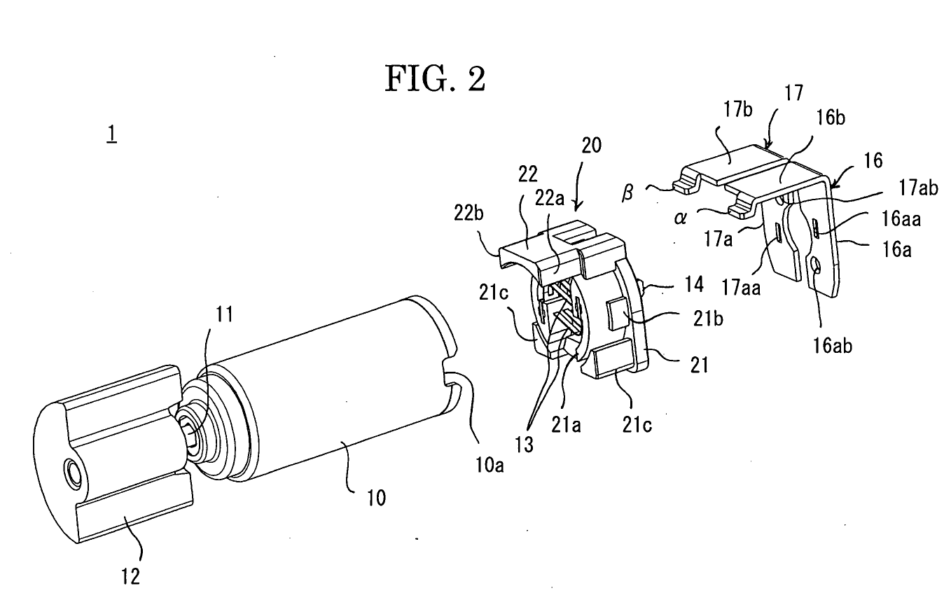

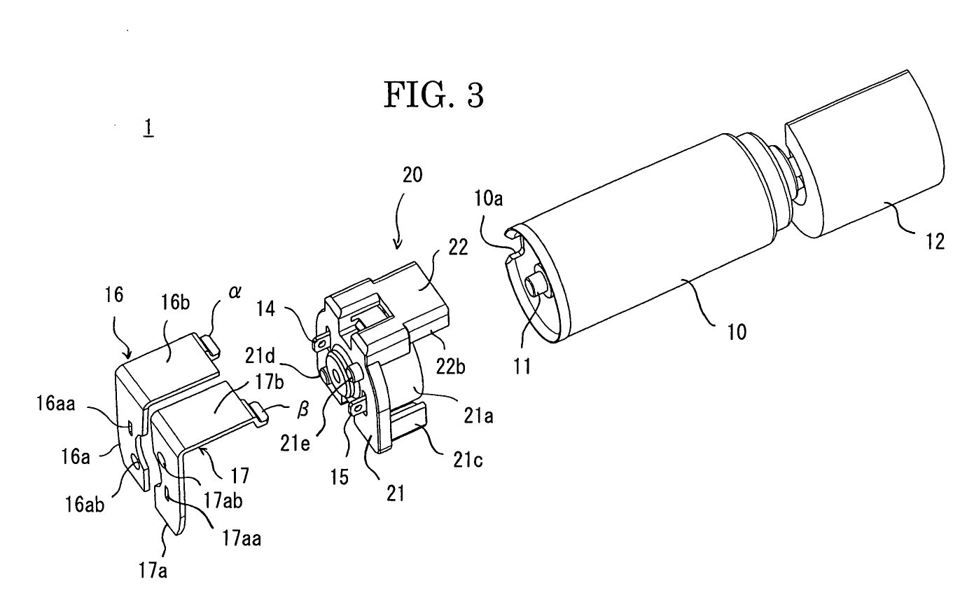

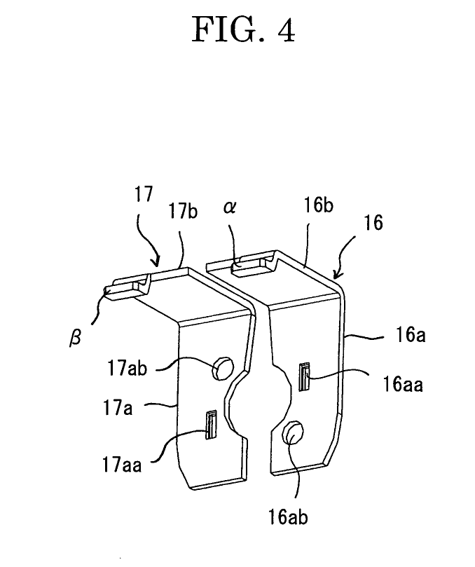

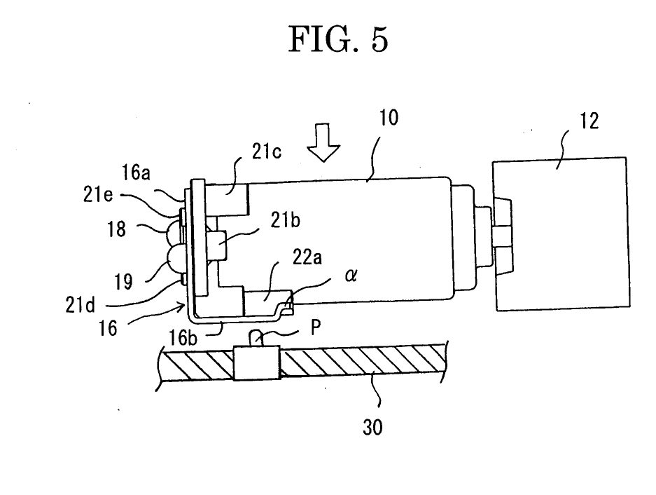

FIG. 1 is an assembled perspective view of a vibration motor according to an embodiment of the present invention, FIG. 2 is a disassembled perspective view with part of the vibration motor detached; FIG. 3 is a disassembled perspective view of the state shown in FIG. 2 seen from another angle; FIG. 4 is a perspective view showing a pair of plate-shaped conduction terminals used for the vibration motor; and FIG. 5 is a side view of the state of mounting the vibration motor on a board.

The vibration motor 1 of this example is comprised of a cylindrically shaped motor case 10 from which projects a motor shaft 11 to which an eccentric weight 12 is attached. The motor case 10 is provided inside it with a magnet (not shown) fixed to its inner circumference, a rotor (not shown) fixed to the motor shaft 11, and a commutator (not shown) fixed to the motor shaft 11 and electrically connected to the rotor. The open end of the motor case 10 is closed by a plastic end cap (end bracket) 20 holding a pair of flanges 13, bearing (not shown), etc.

The end cap 20 has an end cap body 21 made of an insulating plastic and closing the open end of the motor case 10 and a spacer 22 integrally formed with this end cap body 21 and abutting against the circumference of the motor case 10. The bottom face of the spacer 22 is a curved face matching with the circumference of the motor case 10, while the top face of the spacer 22 is a flat face. The end cap body 21 integrally has a tubular part 21a for holding a pair of flanges 13, a turn lock projection 21b fitting into a notch 10a formed at the open end of the motor case 10, and a pair of corner projections 21c, 21c abutting against the circumference of the motor case 10 to prevent turning of the vibration motor 1. At the end face of the end cap body 21 on the opposite side to the eccentric weight, as shown in FIG. 3, a pair motor power parts (relay terminals) 14, 15 connecting to the pair of flanges 13 project out.

These motor power parts (relay terminals) 14, 15 are fit into terminal insertion holes 16aa, 17aa formed in the bent parts 16a, 17a of the corresponding L-shaped plate-shaped conduction terminals 16, 17 and connected there by soldering 18, 19. Further, the bent parts 16a, 17a of the plate-shaped conduction terminals 16, 17 are formed with insertion holes 16ab, 17ab into which insertion projections 21d, 21e of the end face of the end cap body 21 at the opposite side to the eccentric weight are fit. The plate-shaped conduction terminal 16 (17) is provided with a contact face 16b (17b) extending out over the spacer 22. The contact face 16b (17b), as shown in FIG. 5, is fixed to the board 30 side and abuts against the corresponding power contact P. This power contact P is elastically retractable. Further, the first contact face 16b integrally has a first abutting part α abutting against the first side face 22a of the spacer 22, while the second contact face 17b integrally has a second abutting part β abutting against a second side face 22b different from the first side face 22a of the spacer 22. The abutting parts α, β project out from the front ends of the pair of contact faces 16b, 17b near the outer edges opposite to the inner edges where the faces adjoin each other and are bent toward the circumference of the motor case 10.

The spacer 22 is integrally formed with the end cap body 21 and abuts against the circumference of the motor case 10. Further, the power contacts P on the board 30 side are elastically retractable, so the spacer 22 on the vibration motor 1 side and the plate-shaped conduction terminals 16, 17 do not have to be given any special elasticity and unnecessary vibration can be suppressed. Further, the first contact face 16b integrally has a first abutting part α abutting against the first side face 22a of the spacer 22, while the second contact face 17b has a second abutting part β abutting against a second side face 22b different from the first side face 22a of the spacer 22, so the distance between the contact faces 16b, 17b can be constrained and their lateral shaking can be greatly suppressed.

In particular, since the abutting parts α, β project out from the front ends of the pair of contact faces 16b, 17b near the outer edges opposite to the inner edges where the faces adjoin each other and are bent toward the circumference of the motor case 10, the abutting parts α, β press against the spacer 22 at positions furthest away from the base ends of the plate-shaped conduction terminals 16, 17, so provide support at the two ends in structure and can suppress unnecessary vibration. Further, since the abutting parts α, β are formed near the outer edges of the contact faces 16b, 17b, it is possible to increase the widths of the contact faces 16b, 17b to secure greater room for contact with the power contacts P on the board 30 side, and the pair of contact faces 16b, 17b do not have to project out from the motor case 10.

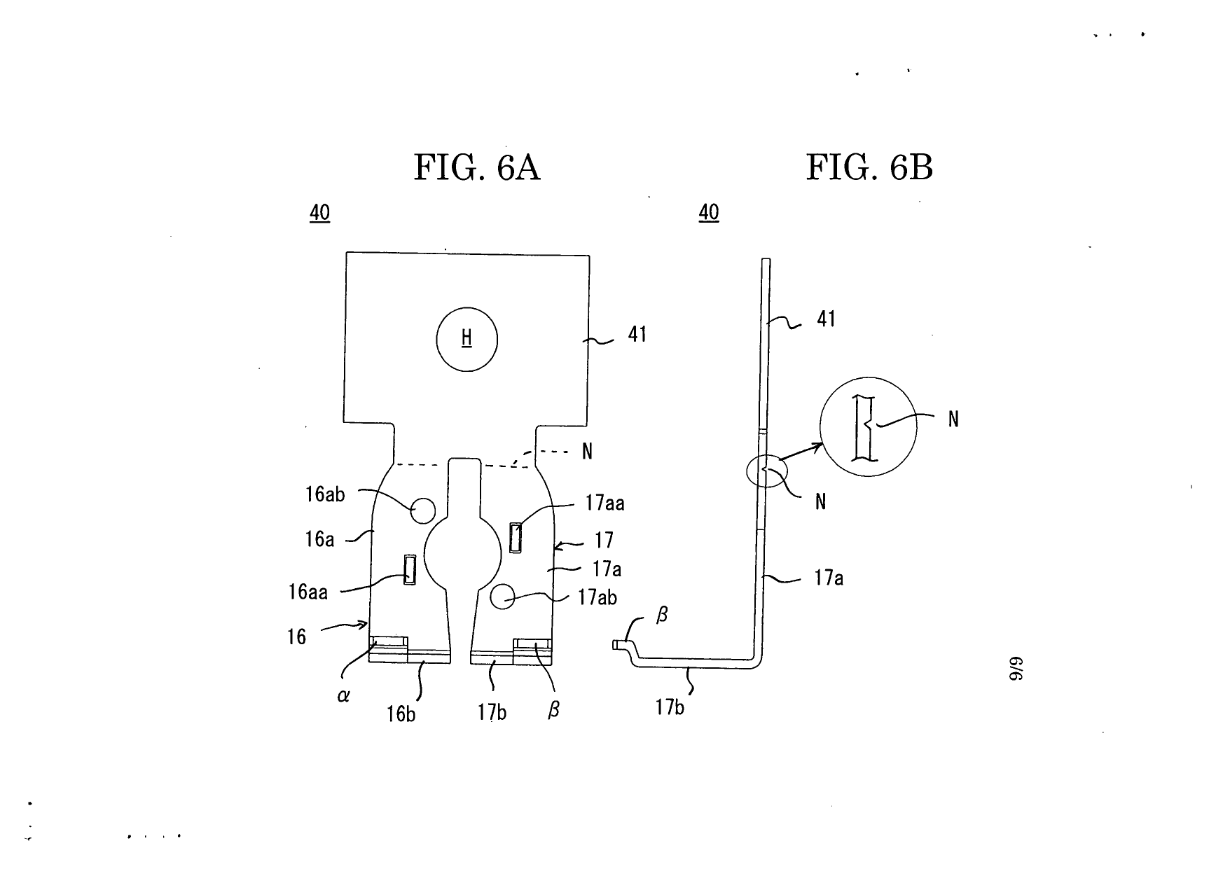

FIG. 6A is a front view of a terminal part 40 provided with a pair of L-shaped plate-shaped conduction terminals 16, 17, while FIG. 6B is a right side view of that terminal part 40.

This terminal part 40 is integrally provided with an attachment piece 41, connecting in a forked manner to the pair of L-shaped plate-shaped conduction terminals 16, 17, projecting out from the pair of bent parts 16a, 17a. The attachment piece 41 is formed with a center hole H. Further, a separating groove N is formed at the boundary of the pair of the bent parts 16a, 17a and the attachment piece 41. Note that the separating groove N may also be provided on the two sides.

The attachment piece 41 of the terminal part 40 is held and the pair of the bent parts 16a, 17a are attached and connected to the pair of motor power parts 14, 15. In that state, the pair of plate-shaped conduction terminals 16, 17 are held at a predetermined distance by being connected by the attachment piece 41 in a forked manner, so the plate-shaped conduction terminals 16, 17 can be connected while maintaining parallelism without separating. Further, since the attachment piece 41 stretches out in the radial direction over the end face of the end cap body 21, it is possible to hold the attachment piece 41 and bend it at the separating groove N to easily break it off so as to remove the attachment piece 41 from the plate-shaped conduction terminals 16, 17. This increases the work efficiency when attaching the plate-shaped conduction terminals 16, 17.

While the invention has been described with reference to specific embodiments chosen for purpose of illustration, it should be apparent that numerous modifications could be made thereto by those skilled in the art without departing from the basic concept and scope of the invention.

1. A vibration motor having
a pair of motor power parts provided at an end cap closing an open end of a motor case,
a pair of plate-shaped conduction terminals including contact faces for abutting against elastically retractable power contacts provided at the board side and connected corresponding to the motor power parts, and
a spacer formed integrally with the end cap and abutting against a circumferential surface of the motor case to separate the contact faces from the circumferential surface, wherein
the first contact face integrally has a first abutting part abutting against a first side face of the spacer and
the second contact face integrally has a second abutting part abutting against a second side face different from the first side face of the spacer.

2. A vibration motor as set forth in claim 1, wherein said abutting parts project out from the front ends of the pair of contact faces near the outer edges opposite to the inner edges where the faces adjoin each other and are bent toward the circumference of the motor case.

3. A vibration motor as set forth in claim 1, wherein each of the pair of plate-shaped conduction terminals is formed into an L-shape having a bent part for connection to corresponding one of said motor power parts and is attached by an attachment piece connecting in a forked manner to the pair of terminals and projecting out from the pair of bent parts and then broken off along a separating groove provided between the pair of bent parts and the attachment part.
